(19) United States
(12) Patent Application Publication
(10) Pub. No.: US 2025/0390445 A1
(43) Pub. Date: Dec. 25, 2025

(54) MICROCONTROLLER WITH HARDWARE-BASED SAFETY SYSTEM

(71) Applicant: Microchip Technology Incorporated, Chandler, AZ (US)

(72) Inventors: Erik Knutsen Renno, Trondheim (NO); Kjetil Kirkholt, Lensvik (NO); Asgeir Schanke, Hegra (NO); Henrik Nyholm, Trondheim (NO); Lloyd Dan Clark, Trondheim (NO)

(73) Assignee: Microchip Technology Incorporated, Chandler, AZ (US)

(21) Appl. No.: 19/249,563

(22) Filed: Jun. 25, 2025

Related U.S. Application Data
(60) Provisional application No. 63/664,025, filed on Jun. 25, 2024.

(51) Int. Cl. G06F 13/10

(52) U.S. Cl. CPC G06F 13/10; G06F 2213/40

(57) ABSTRACT

A microcontroller with a hardware-based safety system is disclosed. The microcontroller may include a bus, a memory control circuitry operatively coupled to the bus, a safety mechanism circuitry operatively coupled to the bus, one or more first peripheral devices operatively coupled to the bus, one or more second peripheral devices operatively coupled to the bus, a comparator to compare output signals from at least one of the memory control circuitry, the safety mechanism circuitry, the one or more first peripheral devices, and the one or more second peripheral devices, and to trigger a fault signal in response of detecting a difference in the output signals, and an error controller operatively coupled to the bus to receive the fault signal and to set the microcontroller to a safe state.

### CROSS-REFERENCE TO RELATED APPLICATION

The present application claims priority from U.S. Provisional Patent Application No. 63/664,025 filed on Jun. 25, 2024, which is incorporated herein by reference in its entirety.

### TECHNICAL FIELD

The present disclosure relates generally to microcontrollers, and more specifically to a microcontroller with a hardware-based safety system.

### SUMMARY

According to an aspect of one or more examples, there is provided a microcontroller. The microcontroller may include a bus, a memory control circuitry operatively coupled to the bus, a safety mechanism circuitry operatively coupled to the bus, one or more first peripheral devices operatively coupled to the bus, one or more second peripheral devices operatively coupled to the bus, a comparator to compare output signals from at least one of the memory control circuitry, the safety mechanism circuitry, the one or more first peripheral devices, and the one or more second peripheral devices to trigger a fault signal in response of detecting a difference in the output signals, and an error controller operatively coupled to the bus to receive the fault signal and to set the microcontroller to a safe state.

The memory control circuitry may include at least one of a static random access memory (SRAM), a Flash memory, a Magnetoresistive Random Access Memory (MRAM), and an Electrically Erasable Programmable Read-only memory (EEPROM), and an error correction code (ECC) circuitry. The safety mechanism circuitry may include a first central processing circuitry, and a second central processing circuitry operating in parallel with the first central processing circuitry to detect one or more errors in execution of a set of instructions. The safety mechanism circuitry may include a first watchdog timer and a second watchdog timer to detect a difference in one or more microcontroller programs and a timing of the one or more microcontroller programs. The first watchdog timer may be synchronous and the second watchdog timer may be asynchronous.

The microcontroller may include an error injection circuitry operatively coupled to the memory control circuitry, the safety mechanism circuitry, the one or more first peripheral devices, and the one or more second peripheral devices to selectively inject errors to modify or replace the output signals to test the fault signal. The safety mechanism circuitry may include an on-chip debugging (OCD) monitor to monitor a status of a first on-chip debugger of a first central processing circuitry and a second on-chip debugger of a second central processing circuitry. The OCD monitor may initiate resetting of one or more microcontroller programs and the microcontroller. The error controller may autonomously handle the fault signal and the microcontroller even when a first central processing circuitry fails to handle the fault signal. The memory control circuitry may rectify one or more single bit errors, and detect one or more multi-bit errors using the error correction code (ECC) circuitry. The safety mechanism circuitry may include a clock inspection circuitry to detect one or more clock faults in a clock generator, and autonomously switch to a fallback clock generator. The clock inspection circuitry may determine one or more clock frequency errors. The safety mechanism circuitry may include a power monitor to detect whether a voltage supplied by a power controller is outside a pre-defined range of voltages.

According to an aspect of one or more examples, there is provided a method. The method may include transmitting data over a bus, comparing output signals from at least one of a memory control circuitry, a safety mechanism circuitry, one or more first peripheral devices, and one or more second peripheral devices using a comparator, generating a fault signal in response to detecting a difference in the output signals, and setting a microcontroller to a safe state in response to the fault signal using an error controller.

The memory control circuitry may include at least one of a static random access memory (SRAM), a Flash memory, a Magnetoresistive Random Access Memory (MRAM), and an Electrically Erasable Programmable Read-only memory (EEPROM), and an error correction code (ECC) circuitry. The method may include detecting one or more errors in execution of a set of instructions using the safety mechanism circuitry including a first central processing circuitry, and a second central processing circuitry operating in parallel with the first central processing circuitry. The method may include monitoring one or more microcontroller programs using a first watchdog timer and a second watchdog timer. The first watchdog timer may be synchronous and the second watchdog timer may be asynchronous. The method may include selectively injecting errors to modify or replace the output signals of the memory control circuitry, the safety mechanism circuitry, the one or more first peripheral devices and the one or more second peripheral devices to test the fault signal using an error injection circuitry.

The method may include monitoring a status of a first on-chip debugger of a first central processing circuitry and a second on-chip debugger of a second central processing circuitry using an on-chip debugging (OCD) monitor and initiating a reset of one or more microcontroller programs and the microcontroller in response to the monitored status. The method may include autonomously handling the fault signal using the error controller even when a first central processing circuitry fails to handle the fault signal. The method may include rectifying one or more single bit errors and detecting one or more multi-bit errors using an error correction code (ECC) circuitry of the memory control circuitry. The method may include detecting one or more clock faults in a clock generator using a clock inspection circuitry, autonomously switching to a fallback clock generator, and detecting one or more clock frequency errors using the clock inspection circuitry. The method may include detecting whether a voltage supplied by a power controller is outside a predefined range of voltages using a power monitor.

### BRIEF DESCRIPTION OF DRAWINGS

FIG. 1 shows a block diagram illustrating a microcontroller according to one or more examples.

FIG. 2 shows a circle diagram illustrating a safety system of a microcontroller according to one or more examples.

FIG. 3 shows a block diagram illustrating a method according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Achieving a high degree of Functional Safety (FuSa) is important in safety-critical applications like automotive, industrial controls, medical devices, and aerospace systems. Functional safety ensures that systems relying on microcontrollers operate reliably, even in the presence of fault or errors, thereby reducing the risk of hazards to users and the environment. These systems may ensure a low Fault detection time interval (FDTI) which represents the maximum time between occurrence of a fault and detection of that fault by the system. The microcontrollers rely on software-based diagnostic self-tests to detect errors. The software-based diagnostic self-tests consume valuable memory and CPU resources. The software-based diagnostic self-tests have limited diagnostic coverage and increased FDTI. Therefore, there is a need for an improved microcontroller with hardware-based safety system.

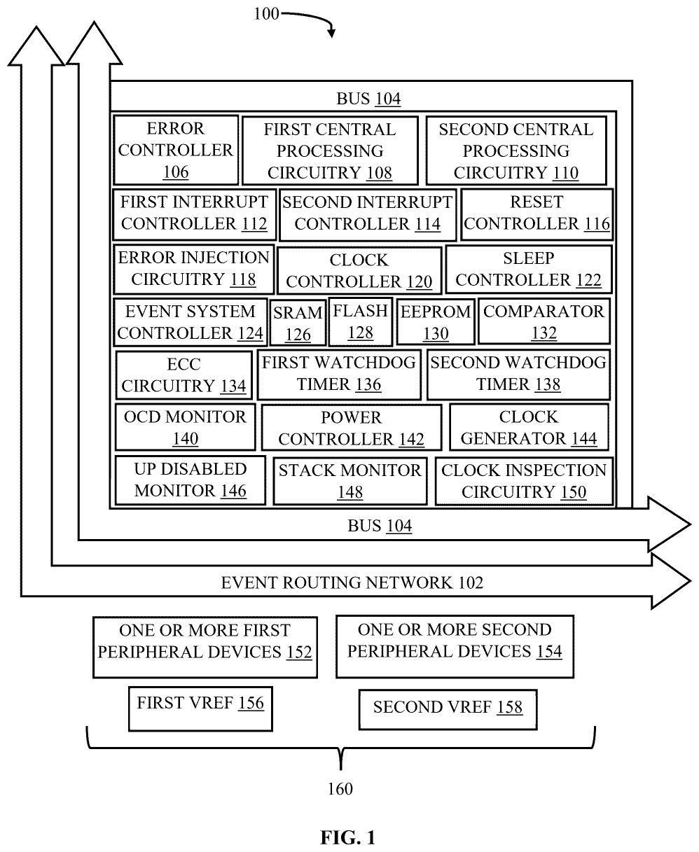

FIG. 1 shows a block diagram illustrating a microcontroller 100 according to one or more examples. The microcontroller 100 may include an event system controller 124 to route events from peripherals 160 on an event routing network 102 and a bus 104 to transmit data between the peripherals 160 and other components of the microcontroller 100. The event system controller 124 may receive instructions from the peripherals 160, such as one or more first peripheral devices 152 and one or more second peripheral devices 154. Each of the one or more first peripheral devices 152 and the one or more second peripheral devices 154 may determine which type of action has to be taken when an event is received on the event routing network 102.

The event routing network 102 may facilitate the efficient and timely transfer of event signals between the peripherals 160 and subsystems within the microcontroller 100. The event routing network 102 may enable asynchronous communication between components of the microcontroller 100, enabling the peripherals 160 to send and receive the event signals without relying on a central processing circuitry. This offloads the central processing circuitry from handling all event-related tasks, thereby reducing its load and increasing the overall efficiency of the microcontroller 100. The event routing network 102 may be operatively coupled to the event system controller 124, which may manage and direct the flow of the events. The event system controller 124 may route the events to a determined destination based on one or more predefined rules.

The microcontroller 100 may include an error controller 106, a first central processing circuitry 108, a second central processing circuitry 110, a first interrupt controller 112, a second interrupt controller 114, a reset controller 116, an error injection circuitry 118, a clock controller 120, a sleep controller 122, a static random access memory (SRAM) 126, a flash memory 128, an electrically erasable programmable read-only memory (EEPROM) 130, a comparator 132, an error correcting code (ECC) circuitry 134, a first watchdog timer 136, a second watchdog timer 138, an on-chip debugging (OCD) monitor 140, a power controller 142, a clock generator 144, a Debug Interface (DI) disabled monitor 146, a stack monitor 148 and a clock inspection circuitry 150. Microcontroller 100 may include a Magnetoresistive Random Access Memory (MRAM) in place of or in addition to, for example, flash memory 128.

The first central processing circuitry 108 and the second central processing circuitry 110 may be in a lockstep mode, where the first central processing circuitry 108 and the second central processing circuitry 110 execute a set of instructions. The second central processing circuitry 110 may operate in parallel with the first central processing circuitry 108 to detect one or more errors in the execution of the set of instructions, program counter, stack pointer, and the interrupt controllers 112 and 114 by identifying differences between the outputs of the first and second central processing circuitries 108 and 110. The first central processing circuitry 108 may include a first on-chip debugger (OCD) and the second central processing circuitry 110 may include a second on-chip debugger (OCD). The OCD monitor 140 may monitor a status of the first OCD of the first central processing circuitry 108 and the second OCD of the second central processing circuitry 110. The OCD monitor 140 may initiate resetting of one or more microcontroller programs and the microcontroller 100.

The first OCD and the second OCD may monitor and debug the set of instructions executed by the first central processing circuitry 108 and the second central processing circuitry 110, respectively. The first OCD and the second OCD may enable inspection of an internal state of the first central processing circuitry 108 and the second central processing circuitry 110, respectively, including register values, memory data, and execution flow, without halting the first central processing circuitry 108 and the second central processing circuitry 110.

The first interrupt controller 112 and the second interrupt controller 114 may handle internal and/or external interrupts for the first central processing circuitry 108 and the second central processing circuitry 110, respectively. The first interrupt controller 112 and the second interrupt controller 114 may provide the first central processing circuitry 108 and the second central processing circuitry 110 with one or more interrupt signals to generate interrupts with different priority levels. The first interrupt controller 112 and the second interrupt controller 114 may include circuitry for gathering and storing other necessary information, such as priority, interrupt source address, timer information and the like, for handling the respective interrupts which can be provided or read respectively by the first central processing circuitry 108 and the second central processing circuitry 110.

The error controller 106 may receive fault signals generated by various components, including the comparator 132, which compares the outputs of the first and second central processing circuitries 108 and 110. Upon detecting a difference between the outputs of the first and second central processing circuitries 108 and 110, the comparator 132 triggers a fault signal, which prompts the error controller 106 to autonomously manage the fault signal, ensuring that the microcontroller 100 transitions to a safe state without intervention from the central processing circuitry. By taking over the fault management process, the error controller 106 enables the microcontroller 100 to maintain safe and reliable operation under fault conditions.

The safe state may enable the microcontroller 100 to isolate itself from an affected or erroneous component of the microcontroller 100 by tri-stating one or more input/output (IO) pins. Tri-stating the one or more IO pins may place the IO pins in a high-impedance state, disconnecting the IO pins from any signals and other components of the microcontroller 100. The error controller 106 may autonomously handle the fault signal and the microcontroller 100 even when the first central processing circuitry 108 fails to handle the fault signal. The error controller 106 may transmit an IO float signal responsive to the fault signal received from the comparator 132. The IO float signal may trigger an electrically floating state of the one or more IO pins of the microcontroller 100 to transition the microcontroller 100 to the safe state.

The microcontroller 100 may include a trap circuit (not shown) to trap one or more undefined instructions (illegal opcodes). The trap circuit may be designed to catch run-away code and execution of data in the flash memory 128. When an illegal opcode is detected, the trap circuit of the microcontroller 100 may generate a trap signal that triggers the fault signal for the error controller 106. The error controller 106 may prevent the execution of the one or more undefined instructions, which may lead to unpredictable behavior of the microcontroller 100 or failure of the microcontroller 100.

The ECC circuitry 134 may check data integrity in various memory components, including the SRAM 126, the flash memory 128 and the EEPROM 130. The ECC circuitry 134 may detect and rectify errors that occur during data storage and retrieval operations. In one or more examples, the ECC circuitry 134 may be a Single Error Correcting and Double Error Detecting Error Correcting Code (SECDED ECC) circuitry. The ECC circuitry 134 may include a generator to generate ECC codes based on the data received for a write operation to at least one of the SRAM 126, the flash memory 128 and the EEPROM 130. The ECC codes may be embedded in the data and stored in at least one of the SRAM 126, the flash memory 128 and the EEPROM 130. During a read operation, the ECC codes may be used for error detection. The ECC circuitry 134, which retrieves the data from at least one of the SRAM 126, the flash memory 128 and the EEPROM 130 and compares the retrieved data through the comparator 132, may include a checker to perform error checking using corresponding ECC codes. The checker may determine if any error occurred while storing or retrieving the data.

In one or more examples, the ECC circuitry 134 may rectify one or more single-bit errors. When a single-bit error is detected, the ECC circuitry 134 may identify the erroneous bit and correct the erroneous bit on-the-fly without interrupting normal operation of the microcontroller 100. In one or more examples, the ECC circuitry 134 may detect one or more multi-bit errors, which are more severe than the one or more single-bit errors. When a multi-bit error is detected, the ECC circuitry 134 through the comparator 132 may trigger the fault signal. The fault signal may be received by the error controller 106, which may set the microcontroller 100 to the safe state.

The microcontroller 100 may include a cyclic redundancy check (CRC) circuit (not shown) to validate an application integrity prior to releasing a first central processing circuitry reset. The CRC circuit may perform a CRC scan on an application code stored in at least one of the flash memory 128, the SRAM 126 and EEPROM 130. The CRC may be an error-detecting code that is used to detect changes in the data. During an initialization phase, before the microcontroller 100 releases the first central processing circuitry 108 from reset, the CRC circuit may calculate the CRC value of the application code stored in at least one of the flash memory 128, the SRAM 126 and EEPROM 130. The calculated CRC value may be compared using the comparator 132 with a predetermined reference CRC value that was generated and stored during the programming of the application code.

If the calculated CRC value matches the reference CRC value, it indicates that the application code is intact and has not been altered or corrupted. In this case, the CRC circuit may signal that the application integrity is verified, allowing the microcontroller 100 to proceed with releasing the first central processing circuitry 108 from reset and starting normal operation. However, if the calculated CRC value does not match the reference CRC value, the CRC circuit may indicate a potential corruption or alteration of the application code. In this scenario, the CRC circuit may generate the fault signal indicating the detection of an integrity violation. The fault signal is sent to the error controller 106. Upon receiving the fault signal from the CRC circuit, the error controller 106 may set the microcontroller 100 to the safe state.

The microcontroller 100 may include a parity check circuit (not shown) for the integrity and reliability of data transmissions on both one or more microcontroller programs and the bus 104. The parity check circuit may calculate parity of each data word during transmission. When a data word is sent from one component to another over the bus 104, the transmitting component may include a selected parity bit. The receiving component may recalculate the parity of the received data word and compare it with the transmitted parity bit.

If the recalculated parity does not match the transmitted parity bit, it may indicate that a transmission error has occurred. The mismatch may be due to transient faults, such as electrical noise, or permanent faults, such as hardware malfunctions in the bus 104. Upon detecting a parity error, the parity check circuit may generate the fault signal. The fault signal may be sent to the error controller 106, which manages such errors. The error controller 106 may perform one or more actions based on severity and type of the fault detected. In response to the parity error, the error controller 106 may initiate a reset of the affected component or transition the microcontroller 100 to the safe state to prevent additional errors and facilitate stability of the microcontroller 100.

The first watchdog timer 136 and the second watchdog timer 138 of the microcontroller 100 may be designed to monitor the operation of the one or more microcontroller programs and detect any anomalies in execution and timing of the one or more microcontroller programs. The first watchdog timer 136 may be synchronous, operating with the central processing circuitries 108 and 110, while the second watchdog timer 138 may be asynchronous, running independently of the central processing circuitries 108 and 110. The first watchdog timer 136 may be operatively coupled to the event routing network 102.

The clock inspection circuitry 150 may continuously monitor clock signals generated by the clock generator 144. The clock inspection circuitry 150 may detect one or more clock faults in the clock generator 144. The one or more clock faults may include frequency deviations, phase errors and one or more other anomalies that hinder the operation of the microcontroller 100. Accurate clock signals may maintain the timing integrity of the microcontroller 100 whereas the one or more clock faults may lead to at least one of incorrect execution sequences, data corruption and instability of the microcontroller 100. To identify one or more clock faults, the clock inspection circuitry 150 utilizes the comparator 132 to compare the clock signals with one or more predefined parameters, including a determined frequency and phase value. In one or more examples, the clock inspection circuitry 150 may autonomously switch to a fallback clock generator (not shown) if the one or more clock faults are detected in the clock generator 144.

The clock inspection circuitry 150 is to determine one or more clock frequency errors. If the clock inspection circuitry 150 identifies a difference from the one or more predefined parameters, the clock inspection circuitry 150 may send the fault signal to the error controller 106 based on the identified clock faults. The error controller 106 may enable the clock inspection circuitry 150 to switch the microcontroller 100 to the fallback clock generator. The fallback clock generator may provide one or more alternative clock signals to maintain the operation of the microcontroller 100.

The error controller 106 may be operatively coupled to the clock controller 120 and the sleep controller 122. In the event of a fault, the error controller 106 may send commands to the clock controller 120 to stabilize or adjust the clock signals generated by the clock generator 144, ensuring consistent operation and preventing timing-related faults. In one or more examples, the error controller 106 may trigger the sleep controller 122 to prevent the microcontroller 100 from inadvertently entering a low-power sleep mode, thereby maintaining active monitoring and control.

The microcontroller 100 may include a power monitor (not shown) operatively coupled with the power controller 142. The power monitor may detect whether a voltage supplied by the power controller 142 is within a predefined range of voltages, which includes a lower voltage limit and an upper voltage limit, to maintain safe operation of the microcontroller 100. The power monitor may continuously monitor the voltage supplied within the microcontroller 100. The power monitor may use the comparator 132 to compare the voltage supplied against the predefined range of voltages. If the voltage supplied by the power controller 142 deviates from the predefined range, the power monitor may identify a power fault. Upon detecting the power fault, such as an under-voltage if the voltage supplied is below the lower voltage limit or an over-voltage if the voltage supplied is above the upper voltage limit, the power monitor may generate the fault signal. The fault signal associated with the power fault may be sent to the error controller 106, which may trigger a transition of the microcontroller 100 to the safe state.

The stack monitor 148 may detect one or more bugs in the one or more microcontroller programs and stack pointer corruption. The stack monitor 148 may monitor a stack pointer register of the central processing circuitries 108 and 110, thereby preventing stack overflows, underflows, and unauthorized stack pointer manipulations. In an event where the stack monitor 148 identifies an anomaly in the stack pointer register, the stack monitor 148 may generate the fault signal for the error controller 106, which may set the microcontroller 100 to the safe state.

The peripherals 160 may include one or more of an analog-to-digital converter (ADC), an analog comparator (AC), and a digital-to-analog converter (DAC). If the peripherals 160 are ADCs, the microcontroller 100 may include two ADCs. Each ADC may operate with an independent voltage reference (VREF), the first ADC with a first VREF 156 and the second ADC with a second VREF 158. By employing the independent voltage reference for each ADC, the microcontroller 100 may detect the one or more errors in analog input and output signals through cross-verification of ADC outputs.

During an operation, both the first ADC and the second ADC concurrently sample the same analog input signal but convert the analog input signal based on the first VREF 156 and the second VREF, respectively. The digital output signals from the first ADC and the second ADC may be compared using the comparator 132. The comparator 132 may detect the difference between the outputs of the ADCs. If the difference is detected, the comparator 132 may generate the fault signal. A person of ordinary skill in the art may consider the difference to be a significant difference, which is a difference greater than a threshold amount and is sufficient to indicate a fault.

The microcontroller 100 may include a heartbeat output signal to allow a higher-ranking system to detect the one or more errors in the microcontroller 100. The heartbeat output signal may be an indicator of normal operation of the microcontroller 100. During the normal operation, the microcontroller 100 generates the heartbeat output signal at regular intervals, indicating that the microcontroller 100 has not encountered the one or more errors. In the event of an error within the microcontroller 100, such as malfunction of the first or second central processing circuitries 108 and 110, corruption of the SRAM memory 126, flash memory 128 and EEPROM 130, or failure of the peripherals 160, the generation of the heartbeat output signal may terminate or deviate from the regular intervals. Moreover, the microcontroller 100 may detect one or more conditions indicative of an accidental sleep event to prevent the one or more errors caused by the accidental sleep event.

The DI disabled monitor 146 may detect the one or more errors resulting from an accidental activation of a debug interface (DI) of the microcontroller 100. The DI disabled monitor 146 may be a unified program debug interface disabled monitor or an ARM debug interface disabled monitor, corresponding to a unified program debug interface and an ARM debug interface respectively. The DI disabled monitor 146 may also involve any other type of debug interface as would be understood by a person of ordinary skill in the art. The DI may be used to program and debug a firmware of the microcontroller 100. The accidental activation of the DI may lead to the one or more errors, including unintended modifications of parameters, code execution errors, or unauthorized access to the data. The DI disabled monitor 146 may actively monitor state of the DI to check that the DI remains disabled under a normal operation of the microcontroller 100. Upon detecting the accidental activation of the DI, the DI disabled monitor 146 may be triggered to send the fault signal to the error controller 106.

The microcontroller 100 may include the first interrupt controller 112 and the second interrupt controller 114, operating in a lockstep mode. In a lockstep operation, the first interrupt controller 112 and the second interrupt controller 114 may execute the same set of instructions concurrently, enabling detection of a difference between the outputs of both the interrupt controllers 112 and 114 using the comparator 132. Upon detection of the difference between the outputs of both the interrupt controllers 112 and 114, the fault signal may be sent to the error controller 106.

The reset controller 116 may be operatively coupled to receive the fault signal from one or more components of the microcontroller 100 and a command signal from the error controller 106. The reset controller 116 may transmit a machine check reset signal responsive to the fault signal or the command signal received from the one or more components of the microcontroller 100 and the error controller 106, respectively. The machine check reset signal may trigger a reset of the microcontroller 100. An interrupt signal may be received by the first interrupt controller 112 and the second interrupt controller 114 in response to the machine check reset signal. The reset controller 116 may transmit the machine check reset signal to some or all components within the microcontroller 100. These components may include the first central processing circuitry 108, the second central processing circuitry 110, the first and second interrupt controllers 112, 114, the SRAM 126, the flash memory 128, the EEPROM 130, and any other components that may need the reset upon fault detection. The error controller 106 may act as a redundant reset controller to set the microcontroller 100 to the safe state even if the reset controller 116 becomes faulty.

The error injection circuitry 118 may be operatively coupled to the one or more components of the microcontroller 100 to selectively inject errors to modify or replace the output signals to test the fault signal. In one or more examples, the error injection circuitry 118 may be employed to insert an error such that the output signals from the one or more components of the microcontroller 100 received by the comparator 132 are altered. The error injection circuitry 118 may be implemented with hardware-based functional safety. The error injection circuitry 118 may be executed during startup or power-off, or even on a request of an administrator.

The microcontroller 100 may include redundancy on one or more communication peripherals (not shown) to increase diagnostic coverage and reduce reliance on software-based diagnostics. The redundant communication peripherals may include communication protocols, such as serial peripheral interface (SPI), general-purpose input/output (GPIO), Inter-Integrated Circuit (I2C), Universal Asynchronous Receiver/Transmitter (UART), and the like. Using the redundant communication peripherals, the microcontroller 100 may perform cross-verification of data transmission. In one or more examples, the microcontroller 100 may include a UART and a redundant UART. During a normal operation, both UARTs may transmit and receive the same data. The comparator 132 may compare the outputs of the UART and the redundant UART. If a difference is detected between the outputs of the UARTs, the fault signal is sent to the error controller 106. The redundancy may enable continuous monitoring of the communication peripherals.

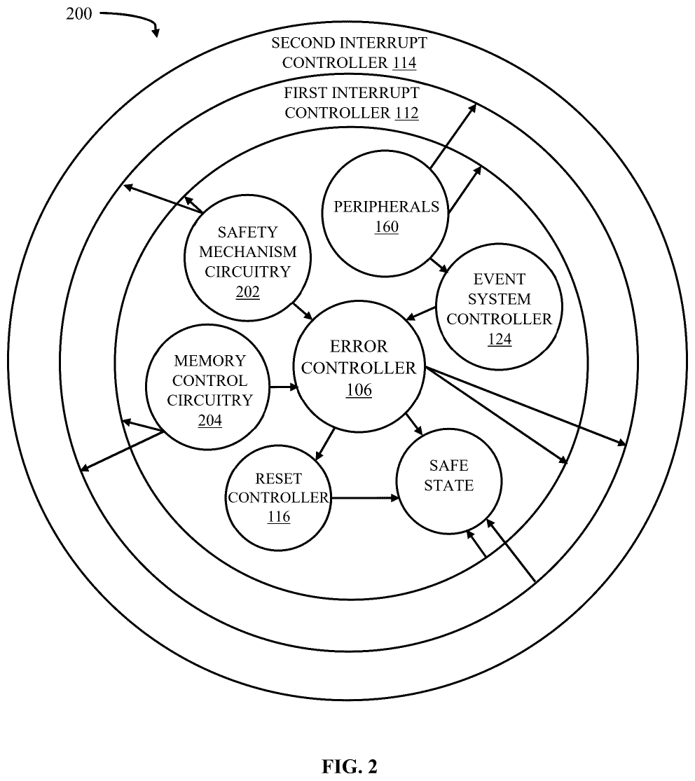

FIG. 2 shows a circle diagram illustrating a safety system 200 of the microcontroller 100 according to one or more examples. It may be noted that in order to explain the safety system 200 of the microcontroller 100, references will be made to the elements explained in FIG. 1. The safety system 200 may include the error controller 106, a safety mechanism circuitry 202, a memory control circuitry 204, the first interrupt controller 112, the second interrupt controller 114, the reset controller 116, the event system controller 124 and the peripherals 160.

The error controller 106 may be operatively coupled to the safety mechanism circuitry 202, the memory control circuitry 204, the first interrupt controller 112, the second interrupt controller 114, the reset controller 116, and the peripherals 160 through the event system controller 124 to monitor and manage fault signals generated by these components. Upon detecting a fault signal from any of these components, the error controller 106 may set the microcontroller 100 to a safe state. The transition may include isolating the affected components and tri-stating the IO pins to prevent unintended outputs, thereby safeguarding the microcontroller 100 and preventing any potential hazards. In various examples, the error controller 106 may set the microcontroller 100 to the safe state through the reset controller 116. In various examples, the error controller 106 may directly set the microcontroller 100 to the safe state.

The safety mechanism circuitry 202 may include the first central processing circuitry 108, the second central processing circuitry 110, the error injection circuitry 118, the comparator 132, the first watchdog timer 136, the second watchdog timer 138, the OCD monitor 140, the power monitor, the DI disabled monitor 146, the stack monitor 148, the clock inspection circuitry 150, the trap circuit, the CRC circuit, the parity check circuit and the heartbeat output signal.

The safety mechanism circuitry 202 may be operatively coupled to the first interrupt controller 112, the second interrupt controller 114, the error controller 106 and the reset controller 116. Upon detecting one or more errors, the safety mechanism circuitry 202 may initiate a transition of the microcontroller 100 to the safe state through various paths. It may directly send an interrupt signal to the first interrupt controller 112 and the second interrupt controller 114, which may then process the interrupt and trigger actions to ensure the microcontroller 100 transitions to the safe state, according to various examples. Alternatively, the safety mechanism circuitry 202 may send a fault signal to the error controller 106, which may manage the fault signal and either directly set the microcontroller 100 to the safe state or instruct the reset controller 116 to perform a reset. Moreover, the safety mechanism circuitry 202 may interact with the reset controller 116 to autonomously initiate a reset and transition the microcontroller 100 to the safe state.

The memory control circuitry 204 may include the error injection circuitry 118, the SRAM 124, the flash memory 128, the EEPROM 130, the comparator 132, and the ECC circuitry 134. The memory control circuitry 204 may be operatively coupled to the first interrupt controller 112, the second interrupt controller 114, the error controller 106 and the reset controller 116. Memory control circuitry 204 may include a Magnetoresistive Random Access Memory (MRAM) in place of or in addition to, for example, the flash memory 128. When an error is detected within any component of the memory control circuitry 204, the safety system 200 may provide one or more routes such that the microcontroller 100 transitions to a safe state. In various examples, the memory control circuitry 204 may send an immediate interrupt signal to the first interrupt controller 112 and the second interrupt controller 114. The first and second interrupt controllers 112 and 114 may handle the interrupt, facilitating one or more determined corrective measures. In various examples, the memory control circuitry 204 may generate a fault signal that is directed to the error controller 106. The error controller 106 may orchestrate a comprehensive fault management response, including possibly engaging the reset controller 116 to execute a reset. The memory control circuitry 204 may directly interact with the reset controller 116 to autonomously trigger a reset, thereby ensuring that the microcontroller 100 is promptly and securely transitioned to a safe state, according to various examples.

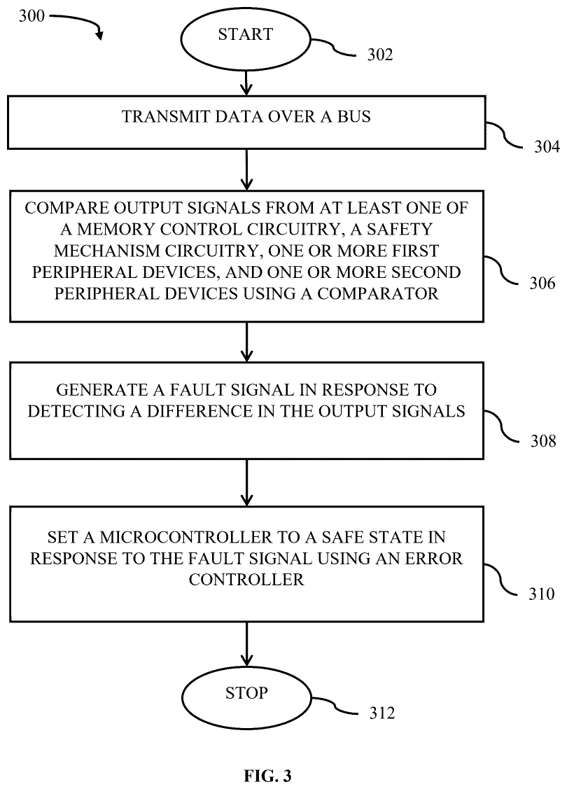

FIG. 3 shows a flowchart 300 illustrating a method according to one or more examples. It may be noted that in order to explain the method operations of the flowchart 300, references will be made to the elements explained in FIGS. 1 & 2.

The flowchart 300 starts at operation 302. At operation 304, the method may include transmitting data over the bus 104. At operation 306, the method may include comparing the output signals from at least one of the memory control circuitry 204, the safety mechanism circuitry 202, the one or more first peripheral devices 152 and the one or more second peripheral devices 154 using the comparator 132. At operation 308, the method may include generating a fault signal in response to detecting a difference in the output signals. At operation 310, the method may include setting the microcontroller 100 to a safe state in response to the fault signal using the error controller 106.

The flowchart 300 terminates at operation 312. It may be noted that the flowchart 300 is explained to have above stated process operations; however, those skilled in the art would appreciate that the flowchart 300 may have more/less number of process operations which may enable all the above stated examples of the present disclosure.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A microcontroller comprising:
a bus;
a memory control circuitry operatively coupled to the bus;
a safety mechanism circuitry operatively coupled to the bus;
one or more first peripheral devices operatively coupled to the bus;
one or more second peripheral devices operatively coupled to the bus;
a comparator to compare output signals from at least one of the memory control circuitry, the safety mechanism circuitry, the one or more first peripheral devices, and the one or more second peripheral devices, and to trigger a fault signal in response of detecting a difference in the output signals; and
an error controller operatively coupled to the bus to receive the fault signal and to set the microcontroller to a safe state.

2. The microcontroller of claim 1, wherein the memory control circuitry comprises at least one of a static random access memory (SRAM), a Flash memory, a Magnetoresistive Random Access Memory (MRAM), and an Electrically Erasable Programmable Read-only memory (EEPROM), and an error correction code (ECC) circuitry.

3. The microcontroller of claim 1, wherein the safety mechanism circuitry comprises a first central processing circuitry, and a second central processing circuitry operating in parallel with the first central processing circuitry to detect one or more errors in execution of a set of instructions.

4. The microcontroller of claim 1, wherein the safety mechanism circuitry comprises a first watchdog timer and a second watchdog timer to detect a difference in one or more microcontroller programs and a timing of the one or more microcontroller programs, wherein the first watchdog timer is synchronous, and the second watchdog timer is asynchronous.

5. The microcontroller of claim 1, further comprising an error injection circuitry operatively coupled to the memory control circuitry, the safety mechanism circuitry, the one or more first peripheral devices, and the one or more second peripheral devices to selectively inject errors to modify or replace the output signals to test the fault signal.

6. The microcontroller of claim 1, wherein the safety mechanism circuitry comprises an on-chip debugging (OCD) monitor to monitor a status of a first on-chip debugger of a first central processing circuitry and a second on-chip debugger of a second central processing circuitry, wherein the OCD monitor is to initiate resetting of one or more microcontroller programs and the microcontroller.

7. The microcontroller of claim 1, wherein the error controller is to autonomously handle the fault signal and the microcontroller even when a first central processing circuitry fails to handle the fault signal.

8. The microcontroller of claim 2, wherein the memory control circuitry is to rectify one or more single bit errors, and detect one or more multi-bit errors using the error correction code (ECC) circuitry.

9. The microcontroller of claim 1, wherein the safety mechanism circuitry comprises a clock inspection circuitry to detect one or more clock faults in a clock generator, and autonomously switch to a fallback clock generator, wherein the clock inspection circuitry is to determine one or more clock frequency errors.

10. The microcontroller of claim 1, wherein the safety mechanism circuitry comprises a power monitor to detect whether a voltage supplied by a power controller is outside a pre-defined range of voltages.

11. A method comprising:
transmitting data over a bus;
comparing output signals from at least one of a memory control circuitry, a safety mechanism circuitry, one or more first peripheral devices, and one or more second peripheral devices using a comparator;
generating a fault signal in response to detecting a difference in the output signals; and
setting the microcontroller to a safe state in response to the fault signal using an error controller.

12. The method of claim 11, the memory control circuitry comprises at least one of a static random access memory (SRAM), a Flash memory, a Magnetoresistive Random Access Memory (MRAM), and an Electrically Erasable Programmable Read-only memory (EEPROM), and an error correction code (ECC) circuitry.

13. The method of claim 11, further comprising detecting one or more errors in execution of a set of instructions using the safety mechanism circuitry comprising a first central processing circuitry, and a second central processing circuitry operating in parallel with the first central processing circuitry.

14. The method of claim 11, further comprising monitoring one or more microcontroller programs using a first watchdog timer and a second watchdog timer, wherein the first watchdog timer is synchronous and the second watchdog timer is asynchronous.

15. The method of claim 11, further comprising selectively injecting errors to modify or replace the output signals of the memory control circuitry, the safety mechanism circuitry, the one or more first peripheral devices and the one or more second peripheral devices to test the fault signal using an error injection circuitry.

16. The method of claim 11, further comprising:
monitoring a status of a first on-chip debugger of a first central processing circuitry and a second on-chip debugger of a second central processing circuitry using an on-chip debugging (OCD) monitor; and
initiating a reset of one or more microcontroller programs and the microcontroller in response to the monitored status.

17. The method of claim 11, further comprising autonomously handling the fault signal using the error controller even when a first central processing circuitry fails to handle the fault signal.

18. The method of claim 11, further comprising rectifying one or more single bit errors and detecting one or more multi-bit errors using an error correction code (ECC) circuitry of the memory control circuitry.

19. The method of claim 11, further comprising:
detecting one or more clock faults in a clock generator using a clock inspection circuitry;
autonomously switching to a fallback clock generator; and
detecting one or more clock frequency errors using the clock inspection circuitry.

20. The method of claim 11, further comprising detecting whether a voltage supplied by a power controller is outside a predefined range of voltages using a power monitor.
